(19) United States
(12) Patent Application Publication
(10) Pub. No.: US 2013/0193077 A1
(43) Pub. Date: Aug. 1, 2013

(54) Neutralization and Precipitation of Silica from High pH Brines

(71) Applicants: Ravi Chidambaran, Canonsburg, PA (US); Pavan Raina, Pune (IN); Narendra Singh Bisht, Pune (IN)

(72) Inventors: Ravi Chidambaran, Canonsburg, PA (US); Pavan Raina, Pune (IN); Narendra Singh Bisht, Pune (IN)

(21) Appl. No.: 13/561,258

(22) Filed: Jul. 30, 2012

Related U.S. Application Data
(60) Provisional application No. 61/515,672, filed on Aug. 5, 2011.

(51) Int. Cl. C02F 1/52

(52) U.S. Cl. CPC C02F 1/52
USPC 210/712; 210/738; 210/729

(57) ABSTRACT

We provide a process for the neutralization and precipitation of high pH brines that eliminates the formation of “gelatinous silica” during neutralization. The high pH brine is neutralized in a two-step neutralization process. In the first step the salt concentration of a high pH brine is built up to a minimum level of 8-12%, and then its pH is reduced to 9-9.5. The partially neutralized brine is allowed a reaction period with mild agitation. Subsequently the pH is further reduced, typically to 8-9. A coagulant and/or a polymer can also be used to enhance the settling or filtration rate of the neutralized stream.

### CROSS-REFERENCE TO RELATED APPLICATIONS

This application claims priority to U.S. Provisional Patent Application No. 61/515,672, filed on Aug. 5, 2011, and incorporated by reference herein.

### BACKGROUND OF THE INVENTION

1. Field of the Invention

Embodiments of the invention relate to methods and apparatuses for the neutralization and precipitation of high pH silica brines.

2. Background of the Related Art

In many industrial situations artisans may find it desirable to neutralize brines. Typically this is done so that the brine or a portion of the brine may be safely and cost effectively disposed of, beneficially reused, or both. This may be the case, for example, in technologies involving extraction of oil from oil sands using steam-assisted gravity drainage. In some situations neutralization of brines may be useful or necessary to prevent scaling during further purification and use of the water stream.

Although a number of chemical species may precipitate during neutralization of brines, silica is one of the most significant. Process design solutions have been designed to handle high silica concentrations in membrane desalination and evaporation systems. Silica solubility in water increases with increase in pH and temperature. These solubility limits, along with concentration limitations, have been well documented. Silica can change its structure as a function of pH. This complicates removal, because silica's solubility additionally depends upon its structure along with the aforementioned temperature dependence. A typical single-step pH reduction is shown in FIG. 1.

At 25° C. and a neutral pH the solubility of silica is about 120 ppm as SiO₂. At a highly alkaline state, silica is ionized and present in soluble form and can have as much as 3000-8000 ppm silica as SiO₂. This high level of silica with high pH in brine cannot be processed for further treatment or disposal until it is neutralized by acid for beneficial reuse or to meet environmental standards cost effectively.

Although silica is very slow to crystallize or precipitate in a macrocrystalline form, in the presence of salt (e.g. NaCl) the dynamics of precipitation change to form a crystalline precipitate instead of a gelatinous substance. The concentration of salt also plays an important role in the gel formation. In the absence of salt the precipitated silica is difficult to filter or separate through settling and decantation.

Typically the residual silica is disposed of by injection in salt caverns or deep wells. The fluffy nature of silica gel causes it to occupy higher volume than other forms of silica, leading to filling the salt caverns prematurely or plugging the underground formation in a deep well during disposal.

From the silica solubility graph (FIG. 2) it is clear that silica solubility increases with an increase in pH. For waters which are naturally low in hardness or can be pretreated to very low hardness, high concentration levels of silica even to an extent of 3000-8000 ppm can be kept in solution by increasing the pH without forming any sediment. These techniques have been extensively followed in different desalination and evaporation processes. The temperature could be lower in RO processes or close to boiling in the evaporation processes. These processes are used to produce permeate or distillate which is the majority of water being processed and create a residual brine which contains high TDS water depending on the concentration and also contains high level of concentrated silica.

Depending on feed water such waters may also contain oil and grease and organic contamination. A typical composition of such brines is described in Table 1.

TABLE 1

| Constitutes of Brine | Average Value | |
|---|---|---|
| pH value | 10 to 13 | |
| Salt concentration | 0.5% to 25% | |
| Silica as SiO2 | 500 to 8000 | ppm |
| Hardness as CaCO3 | <100 to <500 | ppm |

Such concentrated brines need some treatment for further water recovery or disposal, which may involve silica removal by precipitation and pH neutralization. For silica precipitation, pH is typically brought down by neutralization, which involves addition of acid to bring the pH down to desired levels which will be anywhere from 7-9. This may vary based on its subsequent application.

When this high silica brine is neutralized with an acid to a pH of 7-9, the resultant precipitated silica forms a gelatinous substance. This has poor settling properties and is very difficult to handle, separate or filter. It becomes impossible to use this water for any further processing or discharge. Some applications where this water is discharged after conventional neutralization process into salt caverns or deep well injected become very expensive as the caverns fill up very quickly and wells plug, requiring a new well.

### BRIEF SUMMARY OF THE INVENTION

We provide a process for the neutralization and precipitation of high pH brines that eliminates or ameliorates the formation of “gelatinous silica ” during neutralization. This results in the creation of a precipitate that can be settled and filtered.

The high pH brine is neutralized in a “two-step” neutralization process. In the first step the salt concentration of a high pH brine is built up to a minimum level of 8-12% and then its pH is reduced to 9.5 to 10. The partially neutralized brine is allowed a reaction period with mild agitation. The hold up time varies based on the type of brine and silica concentration and other contaminants and may vary from 5-10 minutes, 10-30 minutes, more than 30 minutes, or more than an hour. Subsequently the pH is further reduced, typically to 8-8.5 by the same acid. The amount of acid may be the same or different as the amount added in the first step.

A coagulant and/or a polyelectrolyte polymer can optionally be used to enhance the settling or filtration rate of the neutralized stream. The clarified/filtered supernatant liquid is then processed either for disposal in caverns/deep well or utilized with further pH adjustment as required through conventional treatment methods.

### BRIEF DESCRIPTION OF THE FIGURES

FIG. 1 shows an example of a silica removal process that does not include the stepwise reduction in pH as typically exhibited by embodiments of the invention.

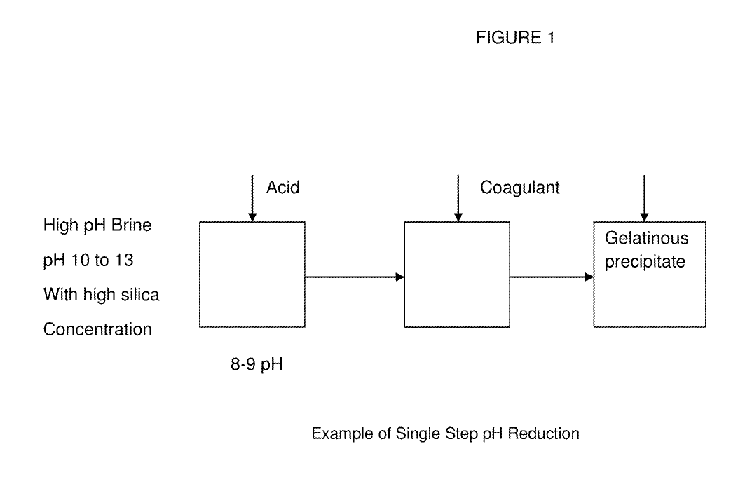

FIG. 2 shows a silica solubility curve reflecting the increasing solubility of silica at increasing pH.

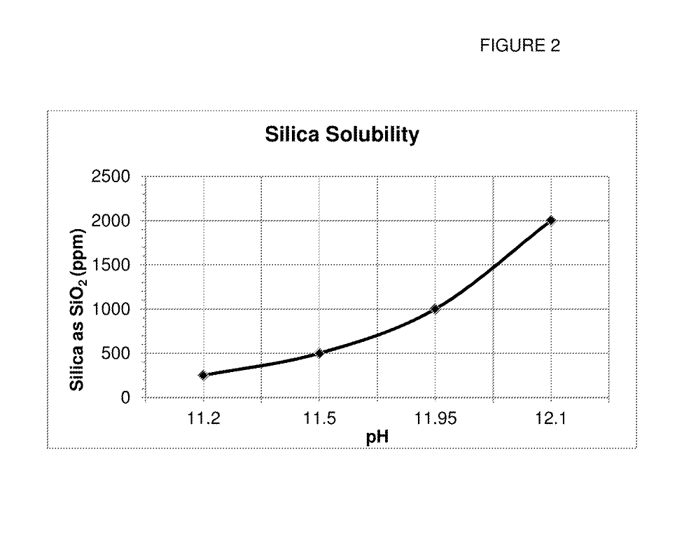

FIG. 3 shows a schematic diagram of one embodiment of a process of neutralization and precipitation of silica from high pH brines as reported herein.

FIG. 4 shows an embodiment of the invention with resulting material going to salt cavern, deep well, or other disposal.

### DETAILED DESCRIPTION OF THE INVENTION

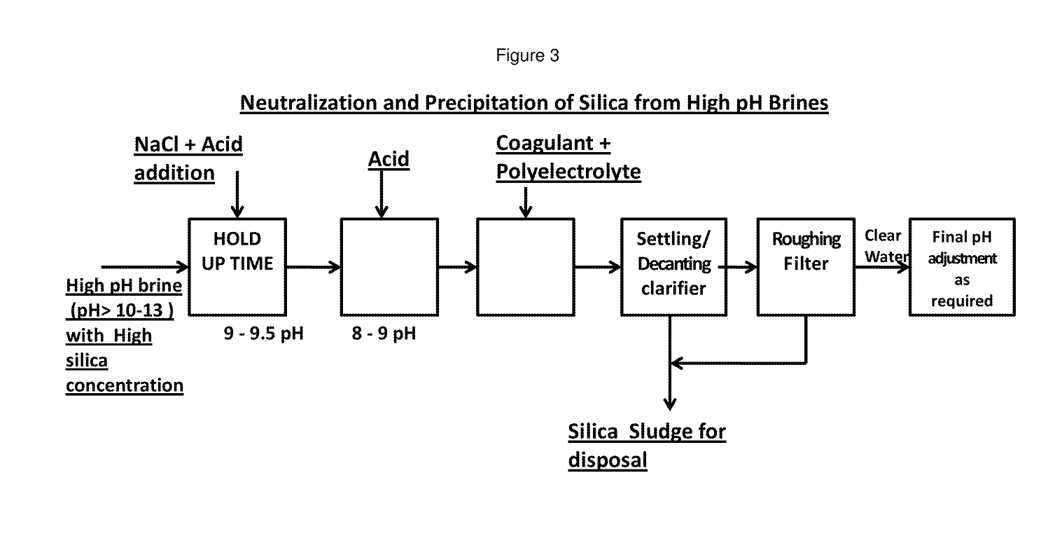

One embodiment of the invention is shown in FIG. 3. In a typical embodiment of the invention, the salt content in a brine will be analyzed to determine the concentration of sodium chloride. In one embodiment the salt content is analyzed by inductively-coupled plasma spectrometer. Preferably the concentration of sodium chloride in the brine to be treated will be, at minimum, between 8-12%. If the concentration of sodium chloride is not at this level, it is adjusted to reach that level. This may be done, for example, through addition of salt, concentrate brine solution, or other sources to make the effective sodium chloride concentration to a minimum of 8-12%. If the concentration is higher than this range, the addition of salt is not required.

After the minimum sodium chloride concentration has been reached, the first pH adjustment is conducted. Of course, those of skill in the art will recognize that when terms such as “first pH adjustment” or “second pH adjustment” are used, they are used relative to the neutralization and precipitation process reported herein. Preceding or succeeding steps are not relevant in determining the “first” or “second” adjustment. Typically adjustment of the solution is done in steps. In a first step, given an expected initial pH range of 10.5-13, the pH is reduced by dosing of acid. This acid may be, for example, but is not limited to hydrochloric or sulfuric acid, depending on availability. Acid dosing reduces the pH to between 9.0-9.5.

Following acid dosing a holdup time is given for silica separation and precipitation. Mild agitation should be continued in this period. After the residence time, and without separating the precipitates, the pH of the brine is reduced to around 8-9 by again dosing acid. The residence time may be, for example, between 10-120 minutes, 10-30 minutes, 30-90 minutes, 30-60 minutes, 60-90 minutes, or 60-120 minutes.

Following or during the second acid dosing, a coagulant may be dosed. In one embodiment a coagulant dose of around 50-100 ppm makes the supernatant clearer. Ferric chloride has worked well and is a preferred coagulant, though those skilled in the art will, with the benefit of this disclosure, recognize that other coagulants may be useful.

Residence time for the coagulant is typically from half an hour to one hour to help enable better filtration. After providing some residence time clear water can be separated by decantation/clarification and/or filtration.

In some application addition of a polymer further accelerates the settling properties. Clarified water has a better turbidity value, which reflects the quality of separation and filtration for subsequent purpose.

The brine obtained can be passed through a filter to a storage tank for any subsequent application. The pH of clarified brine could be further adjusted to suit a subsequent use as well. Instead of decanting the water the precipitated solids can also be filtered to remove the sludge and separate clear water for further processing. “Sludge,” generally, describes a residual semi-solid material left over from wastewater purification. The filter can be, for example, a filter press, belt press, centrifuge or any other clarification, decanting or sludge separation and compaction device depending on the application and purpose.

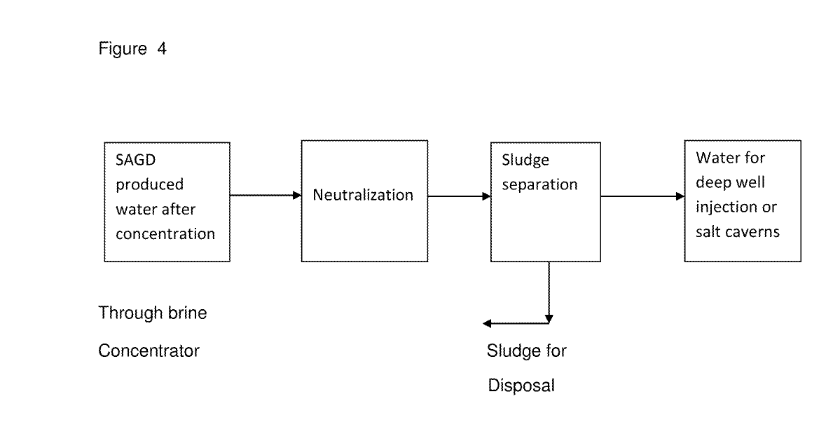

In one embodiment of the invention the produced water from which silica is separated is a concentrated produced water from steam-assisted gravity drainage. Following removal of silica sludge the remaining water, if not re-used, is disposed of by deep well injection or in salt caverns. One example of such an embodiment is shown in FIG. 4.

Embodiments of the invention may have one or more advantages over conventional neurtalization process, though this list should not be construed to limit the scope of the claims.
1. There is no silica gel formation.
2. The silica precipitate settles very well.
3. Settling time is fast.
4. The supernatant can be easily decanted or clarified in a clarifier or sludge can be easily dewatered. Alternatively the sludge can be easily be filtered and sludge separated.
5. The filtration properties are significanty superior to past methods because they allow the capture of significant filtrate and dewatering of slude reducing the suldge volume allowing its compaction
6. The sludge can be compacted and sludge volume can be reduced.
7. Filtrate can be sent to salt caverns or deep well injections without any risk of filling or plugging them up quickly to achieve longer life. Longer life is procured from these storage facilities by making better use of the available storage volume to store equivalent masses of disposed materials. Also the gelatenous silica precipitate if not removed through proper filtration will occupy a siginificant volume which is not the case here.
8. This process can be used at a wide range of temperatures for both reverse osmosis reject streams and evaporator blow downs.

### EXAMPLES

A series of experiments were conducted explore and devise a process for the neutralization and precipitation of silica from high pH brine. To cover a wide range of silica concentration and different salt concentrations, simulated water was used in all of the tests. Sodium chloride (NaCl) was used to increase the salt level of water and sodium meta-silicate nonahydrate (Na₂SiO₃.9H₂O) was used for silica concentration buildup. During water simulation testing, some conditions were maintained as set forth below.
1. High silica content: Theoretical amount of sodium meta-silicate nonahydrate was added to de-mineralize water to simulate the silica concentration. Silica concentration experimented was in the range between 300 ppm and 5000 ppm as SiO₂.
2. Salt concentration: salt concentration was used in a wide range from 0.5% to 25% concentration.

13. pH value: The pH of simulated water was maintained above 10.

In the first phase of the experiments 0.5% to 5% sodium chloride level was maintained and silica was added to get 300-ppm to 3000 ppm in simulated water. Only pH alteration by acid was attempted to get all silica precipitated. At this stage pH was brought down to 7.0 to 8.0 but all cases ended up with the formation of “gelatinous silica.” The characteristics of “gelatinous silica” have been described above. To avoid this gel formation, some other coagulants (Alum & Ferric chloride) were also explored.

Alum was first tried at low pH (7-8) to get a better settling of silica gel, but no significant impact was observed. A combination of alum and polyelectrolyte also did not work to settle fluffy gelatinous silica. At high pH alum was tried to get co-precipitation of silica along with aluminum hydroxide. But extra doses of alum only reduced pH drastically and formation of gelatinous floc occurred. Lesser amounts of alum were not sufficient to reduce silica at higher pH.

Another coagulant (Ferric chloride) was also tried out in a similar fashion but results were more or less the same as with alum. Ferric chloride alone could not reduce the silica at higher pH range. If the pH is lowered with the aid of hydrochloric acid, formation of “gelatinous silica” was observed. Excess dosing of ferric chloride also resulted in formation of the gelatinous floc.

Then in the second phase the salt (sodium chloride) concentration was varied up to 25% and it was observed that a minimum 8% of salt concentration was required to prevent “gelatinous silica” formation and obtain fast settle-able silica precipitation with two step pH reduction. This reduction involved a first adjustment to pH 9.0-9.5 and then an adjustment to pH 8. Adjustments were made through the utilization of acid with the aid of coagulant to get clear supernatant liquid.

Based on these findings an overall process was conceived wherein the salt was added to a threshold level, typically a concentration of between 8-12%, which varied on the brine composition and silica concentration followed by a two step neutralization. The first step involves pH reduction to 9-9.5, followed by a second stage pH reduction and coagulant addition. This enabled achievement of pH in the desirable range and precipitation of silica with good settling particle properties as detailed in Example 3.

### Example 1: (Comparative Example)

A high pH brine (pH 11.95, salt concentration 2% and silica as SiO₂ 2000 ppm) was prepared by dissolving an appropriate amount of sodium Meta silicate nonahydrate and sodium chloride in de-mineralized water. This high pH brine was neutralized by hydrochloric acid to a pH 8.0 and alum (100 ppm and 200 ppm) was added as a coagulant. A gelatinous formation was observed. The formed gel remained suspended and occupied more than 50% of the volume of brine. The residual silica was checked in supernatant liquid and found to be around 160 ppm. The treated water was difficult to decant and filter and would plug any filtration media. The observation results of the experiment are tabulated in Tables 2 & 3.

TABLE 2

| | | pH | Silica as | |
|---|---|---|---|---|
| SN | Water descriptions | value | SiO2 (ppm) | Observation |
| 1 | Simulated water + 2% NaCl | 11.95 | 2000 | |
| | 100 ppm Alum added | | | |
| 2 | pH reduced by HCl to 10 | 10.0 | 929 | |
| 3 | pH reduced by HCl to 8 | 8.0 | 159 | Gel was |
| | | | | formed |

TABLE 3

| | | pH | Silica as | |
|---|---|---|---|---|
| SN | Water descriptions | value | SiO2 (ppm) | Observation |
| 1 | Simulated water + 2% NaCl | 11.95 | 2000 | |
| | 200 ppm Alum added | | | |
| 2 | pH reduced by HCl to 10 | 10.0 | 810 | |
| 3 | pH reduced by HCl to 8.0 | 8.0 | 156 | Gel was |
| | | | | formed |

* Silica checked after ¾ hours

### Example 2: (Comparative Example)

Example 1 was repeated, and this time ferric chloride (50 ppm to 200 ppm) was used as coagulant instead of Alum. Ferric Chloride was dosed in simulated water and the pH was reduced by hydrochloric acid to 8.0. Residual silica was checked first at reduced pH 10 and then pH 8.0. After neutralization to pH 8.0, gelatinous silica formation was observed. The results are summarized in Table 4.

TABLE 4

| | | pH | Silica as |
|---|---|---|---|
| SN | Water descriptions | value | SiO2 (ppm) |
| | Simulated water + 2% NaCl | 12.25 | 1895 |

Part-1: Ferric chloride added and pH reduced to 9.5 by HCl

| | | | |
|---|---|---|---|
| 1 | 50-ppm FeCl₃ | 10 | 760 |
| 2 | 100-ppm FeCl₃ | 10 | 710 |
| 3 | 200-ppm FeCl₃ | 10 | 630 |

Part-2: pH further reduced to 8.0 by HCl

| | | | |
|---|---|---|---|
| 1 | 50-ppm FeCl₃ | 8.0 | 180 (Gel was formed) |
| 2 | 100-ppm FeCl₃ | 8.0 | 165 (Gel was formed) |
| 3 | 200-ppm FeCl₃ | 8.0 | 170 (Gel was formed) |

As reflected in Table 4, in comparative examples 1 and 2, above, the silica reduction were found to be in the range of 160-170 ppm from 2000 ppm but a gelatinous formation was observed which occupied almost 50-80% of the liquid volume and once it formed could not be separated.

### Example 3

In this experiment the simulated high pH brine (2000 ppm silica and 2% NaCl water) was treated and neutralized as per a process reported in the Detailed Description herein. Different percentages of sodium chloride (8% to 23%) were added to the high pH simulated brine, and pH was reduced first to 9.5 by hydrochloric acid, kept for 2 hours with mild agitation and then pH was further reduced to 8.0. No gel formation was observed.

The silica precipitated and settled easily but the supernatant liquid was not clear, it was slightly turbid. Then 50-ppm of FeCl₃ was added to the treated water with polyelectrolyte (1-2 ppm). The supernatant treated water became clear. The residual silica results are summarized in Table 5

TABLE 5

| | | | | First | | Second | | Residual |
|---|---|---|---|---|---|---|---|---|
| | | Brine | Salt | Neutralization | Hold | Neutralization | FeCl₃ | Silica as |
| SN | Descriptions | pH | addition | pH point | up time | pH point | dose | SiO2 |
| 1 | Simulated brine | 12.85 | 8% | 9.5 | 2 hrs | 8.0 | 50 ppm | 120 ppm |
| | (2% NaCl + 2000 | | | | | | | |
| | ppm SiO2) | | | | | | | |
| 2 | Simulated water | 12.85 | 13% | 9.5 | 2 hrs | 8.0 | 50 ppm | 102 ppm |
| | (2% NaCl + 2000 | | | | | | | |
| | ppm SiO2) | | | | | | | |
| 3 | Simulated water | 12.85 | 18% | 9.5 | 2 hrs | 8.0 | 50 ppm | 85 ppm |
| | (2% NaCl + 2000 | | | | | | | |
| | ppm SiO2) | | | | | | | |
| 4 | Simulated water | 12.85 | 23% | 9.5 | 2 hrs | 8.0 | 50 ppm | 60 ppm |
| | (2% NaCl + 2000 | | | | | | | |
| | ppm SiO2) | | | | | | | |

### Observations of the Experiment:

1. No gelatinous formation was observed.
2. The precipitates settled down within half an hour and the supernatant appeared clearer.
3. The sludge volume was around 10-20% of the liquid volume and settled down as compact sludge, which could be filtered easily.
4. Almost 94% to 97% of silica precipitated and settled down. The silica reduction increased with an increase in salt concentration.
5. The dosing of coagulant could be done simultaneously with the addition of second step of acid or even just before the addition of the second step acid.

### Example-4

In this experiment, simulated high pH brine with 10% salt concentration was prepared with silica concentration of 300 ppm to 2000 ppm as SiO2 and neutralized in two step process by acid as per the devised process.

The residual silica was checked at each step. No gel formation were observed and the residual silica results are summarized in table-6

TABLE 6

| | | | First | | Second | | Residual |
|---|---|---|---|---|---|---|---|
| | | Brine | Neutralization | Hold | Neutralization | FeCl₃ | Silica as |
| SN | Descriptions | pH | pH point | up time | pH point | dose | SiO2 |
| 1 | Simulated brine | 11.45 | 9.5 | 2 hrs | 8.0 | 50 ppm | 100-ppm |
| | (10% NaCl + 300 | | | | | | |
| | ppm SiO₂) | | | | | | |
| 2 | Simulated water | 11.70 | 9.5 | 2 hrs | 8.0 | 50 ppm | 110-ppm |
| | (10% NaCl + 500 | | | | | | |
| | ppm SiO₂) | | | | | | |
| 3 | Simulated water | 11.90 | 9.5 | 2 hrs | 8.0 | 50 ppm | 112-ppm |
| | (10% NaCl + 800 | | | | | | |
| | ppm SiO₂) | | | | | | |
| 4 | Simulated water | 12.08 | 9.5 | 2 hrs | 8.0 | 50 ppm | 111-ppm |
| | (10% NaCl + 1200 | | | | | | |
| | ppm SiO₂) | | | | | | |
| 5 | Simulated water | 12.15 | 9.5 | 2 hrs | 8.0 | 50 ppm | 115-ppm |
| | (10% NaCl + 1500 | | | | | | |
| | ppm SiO₂) | | | | | | |
| 6 | Simulated water | 12.25 | 9.5 | 2 hrs | 8.0 | 50 ppm | 124-ppm |
| | (10% NaCl + 2000 | | | | | | |
| | ppm SiO₂) | | | | | | |

### Observations of the Experiment:

1. No gel formation was observed in any of the cases. The settled precipitates were powder like solids occupying only a small volume of around 10-15% of liquid from the bottom after settling.
2. Decantation of supernatant liquid was easy with clear supernatant.
3. The sludge could be easily separated by filtration unlike experiment 1 and 2 where filtration properties were sluggish and sludge could not be separated.

### Example 5

In this experiment alum was used as a coagulant and sulfuric acid was used for pH reduction. In previous experiment 1 to 4, the brine was simulated by adding only sodium meta-silicate nonahydrate and sodium chloride in dematerialized water but in this experiment the brine was simulated by adding various reagents based on a produced water analysis as listed in Table 7. “Produced water” is water that, for example, results from heavy oil production from steam assisted gravity drainage.

TABLE 7

| Produced Water Parameters | Results (ppm) |
|---|---|
| pH | 12.5 |
| Calcium as Ca | 80 |
| Magnesium as Mg | 20 |
| Sodium as Na | 3170 |
| Potassium as K | 350 |
| Chloride as Cl | 517 |
| Bicarbonate as HCO₃ | 7500 |
| Nitrate as NO₃ | 35 |
| Sulfate as SO₄ | 117 |
| Silica as SiO₂ | 3180 |
| TDS | 14969 |
| Salt concentration | 1.5% |

For simulation of the above produced water composition brine various chemicals listed in Table 8 were added in one liter of dematerialized water.

TABLE 8

| Chemicals added | Weight of chemicals | |
|---|---|---|
| CaCl₂•2H₂O | 0.294 | gms |
| MgCl₂•6H₂O | 0.167 | gms |
| KCl | 0.667 | gms |
| Na₂SO₄ | 0.173 | gms |
| NaNO₃ | 0.048 | gms |
| Na₂SiO₃•9H₂O | 15.013 | gms |
| NaHCO₃ | 10.329 | gms |
| Demineralized water | 1000 | gms |

After simulation, the high pH brine was divided into two equal parts (part-1 & part-2)

### Part-1:

The part-1 brine was treated as per the method taught in this disclosure. First 8.5% NaCl was added and then the pH was reduced by sulfuric acid to 9.5 and kept for 1-2 hours with mild agitation. After that, the pH was further reduced to 8.0 and 50 ppm of alum was added. No gelatinous floc was formed and silica precipitates settled down easily. The residual silica results of the experiment are tabulated in Table 9. The results were identical when the coagulant was added just before the second lot of acid was added for second step pH adjustment.

TABLE 9

| | | First | | Second | | Residual |
|---|---|---|---|---|---|---|
| | Brine | Neutralization | Hold | Neutralization | Alum | Silica |
| Part-1 Brine | pH | pH point | up time | pH point | dose | as SiO2 |
| Simulated brine | 12.50 | 9.5 | 2 hrs | 8.0 | 50 ppm | 110-ppm |
| (1.5% NaCl + 3180 | | | | | | |
| ppm SiO₂) | | | | | | |

### Part 2:

The part 2 brine was concentrated 6.5 times by heating and evaporation method to make its salt concentration 10%. When the salt concentration reached 10%, the solution was neutralized in two steps by sulfuric acid as per the disclosed process. 50 ppm alum was used for clear supernatant liquid. The residual silica results and observation are tabulated in table-10.

TABLE 10

| | | Concentration | Brine salt | First | | Second | | Residual |
|---|---|---|---|---|---|---|---|---|
| | Brine | by | level after | Neutralization | Hold | Neutralization | Alum | Silica as |
| Part-2 Brine | pH | heating | heating | pH point | up time | pH point | dose | SiO2 |
| Simulated brine | 12.50 | 6.5 times | 10% | 9.5 | 2 hrs | 8.0 | 50 ppm | 75-ppm |
| (1.5% NaCl + 3180 | | | | | | | | |
| ppm SiO₂) | | | | | | | | |

In part 1 and part 2 brine of Example 5, no gelatinous floc was formed; silica precipitated and settled down easily with a sludge volume around 15% of the brine volume. The treated supernatant liquid can be easily decanted or clarified and then it can be processed either for disposal in caverns/deep well or utilized by further pH adjustment as required through conventional treatment method.

Although various embodiments and aspects of the invention have been reported in the foregoing disclosure and appended drawings and claims, it will be appreciated that those of skill in the art would be able to make various modifications and additions, which would be encompassed within the spirit and the scope of the claims.

We claim:

1. A process for removal of silica from brine, comprising:
in a brine having a sodium chloride concentration, silica as silicon dioxide, and a pH between 10 to 13, adjusting the sodium chloride concentration to between 8% and 12%;
adding a first volume of an acid to the brine until the pH of the brine is reduced to between 9.5 to 10;
agitating the brine;
adding a second volume of an acid to the brine until the pH of the brine is reduced to between 8 to 8.5; and
removing silica from the brine as a precipitate, leaving a liquid portion of said brine.

2. The process of claim 1, wherein said brine agitating step is conducted for at least 30 minutes.

3. The process of claim 1, wherein the first volume of acid and second volume of acid are the same or different acids and are selected from the group consisting of hydrochloric acid, nitric acid, phosphoric acid, and sulfuric acid.

4. The process of claim 1, wherein the coagulant is selected from the group consisting of ferric chloride and alum.

5. The process of claim 1, wherein said brine is a produced water.

6. The process of claim 5, wherein said produced water is from a steam assisted gravity drainage process.

7. The process of claim 1, further comprising disposing of said precipitate and re-using said supernatant.

8. The process of claim 1, wherein said precipitate is a compact silica sludge.

9. The process of claim 1, wherein said brine is a product of at least one brine concentrator.

10. The process of claim 1, wherein said precipitate does not comprise gelatinous silica.

11. The process of claim 1, wherein said silica is present in the brine in an amount greater than 300 ppm.

12. The process of claim 1, wherein said silica is present in the brine in an amount between 300 ppm and 8000 ppm.

13. The process of claim 1, further comprising adding a second volume of an acid simultaneously with adding at least one of a coagulant and a polymer to the brine.

14. The process of claim 1, wherein the steps of adding a first volume of an acid and adding a second volume of an acid are separated by at least 10 minutes.

15. The process of claim 1, wherein the steps of adding a first volume of an acid and adding a second volume of an acid are separated by between 10 to 30 minutes.

16. The process of claim 1, further comprising adding at least one of a coagulant and a polymer to the brine is a required step.

17. The process of claim 1, wherein said brine has a sodium chloride concentration between 0.5% and 25% and silica as silicon dioxide between 500 ppm and 8000 ppm.

18. The process of claim 1, wherein said removal of silica is accomplished by decanting the brine.

19. The process of claim 1, wherein said removal of silica is accomplished by filtering the brine.

20. A process for removal of silica from brine and disposal of the removed silica, comprising:
providing a brine comprising residual silica as silicon dioxide, wherein said brine has a pH between 10 to 13;
if the brine has a sodium chloride concentration below 8%, adjusting the sodium chloride concentration of the brine to between 8% to 12%;
adding a first volume of an acid to the brine until the pH of the brine is reduced to between 9.5 to 10;
agitating the brine;
adding a second volume of an acid to the brine until the pH of the brine is reduced to between 8 to 8.5;
filtering silica from the brine as a precipitate, leaving a liquid portion of said brine as a supernatant; and
disposing of the silica.

21. The method of claim 20, further comprising adding at least one of a coagulant and a polymer to the brine.

22. A process for removal of silica from brine, comprising:
in a brine having a sodium chloride concentration, silica as silicon dioxide, and a pH between 10 to 13, adjusting the sodium chloride concentration to between 8% and 12%;
adding an acid to the brine until the pH of the brine is reduced to between 9.5 to 10;
agitating the brine;
removing silica from the brine through at least one of decanting the brine and filtering the brine, leaving a liquid portion of said brine.
